(19) United States
(12) Patent Application Publication
(10) Pub. No.: US 2011/0315833 A1
(43) Pub. Date: Dec. 29, 2011

(54) SURFACE ANCHOR WITH AUTOMATIC COVER

(76) Inventor: Ramon LILLO OLMEDA, Alicante (ES)

(21) Appl. No.: 13/148,843

(22) PCT Filed: Mar. 15, 2010
(86) PCT No.: PCT/ES10/00103

§ 371 Date: Aug. 10, 2011

(30) Foreign Application Priority Data
Mar. 16, 2009 (ES) P200900838

(51) Int. Cl. F16M 11/04; F16M 11/20

(52) U.S. Cl. 248/121; 248/156

(57) ABSTRACT

Surface anchor with automatic cover, for firmly and securely fixing a functional surface element, which includes a surface anchoring device (1) to be cemented in a perforation in the ground, with a tubular surface anchoring structure (3) inside which is attached a coupling device on which is screwed, using a simple quick locking screw, a support device (2) for a parasol or other functional surface device, with an automatic covering device (31) that plugs the device when not in use, preventing tripping accidents, and the ingress of external bodies.

The present invention relates to a surface cover with automatic cover for supporting a parasol which is required to be firmly and securely fixed in the ground, with an automatic cover integrated in it. Alternatively, the anchor may be used to fit another device, for example a post for controlling access to persons and/or vehicles or other functional surface device.

When parasols are installed in hard surfaces such as terraces and on hotel premises, bases or feet are used, fixed by weight or screwed, or with drilled holes in the surface for securing the parasol.

Where bases are used the main problem is the obstacle which these devices present, as well as the difficulty in transferring them due to their heavy weight, since they have to be taken up daily, outside commercial hours, n the case of terraces on the public highway.

On the hand, the use of drilled holes made on the surface, although they have considerable advantages in that they avoid the inconveniences of the aforementioned bases, constitute a danger to all one's acquaintances when the parasol is not installed, since they cause tripping and other types of accidents to the diners. As a result of this municipal regulations are being introduced which prohibit their use on the public highway, despite their convenience.

The object of the present invention is to provide a surface anchor which guarantees the secure fixing of the parasol in the ground, without the need for an additional base or foot and which also incorporates an automatic cover which keeps the device flush to the surface when the parasol is removed, thus avoiding the ingress of external bodies, as well as preventing diners from tripping.

According to the present invention this object is achieved by providing a surface anchor for the fast, simple and safe assembly and removal of a parasol which is manufactured from materials with a high structural strength and with resistance to corrosion, for which purpose the supporting components may preferably be produced entirely of steel. Said anchor will be secured in the ground in total safety by cementing in a hole drilled in the surface. The materials which may be used for cementing it, as well as the method for carrying out the levelled drilling, are not the object of this invention and are, moreover, well known by persons skilled in the art. For this reason they will not be described in the present specification.

A tubular parasol support, which is securely fixed and locked in said anchor, will then be assembled on said anchor, already cemented, by simple screwing. The parasol is then fitted by conventional means to the tubular parasol support. If the assembly is required to be dismantled the parallel will first be removed, as it would in the case of any other parasol support, and the support of the invention is removed by simple manual unscrewing, after a quick locking mechanism is released. However, according to one characteristic of the invention, said locking mechanism may be activated by the self-weight of the parasol, and may similarly be automatically deactivated when the parasol is removed.

For this purpose the invention comprises two main structures, a first structure which is fixed in the ground, flush with the same, this being the device for anchoring to the surface, and a second structure, to which is coupled the parasol, called the parasol support device, which is mounted on the first structure. The first comprises a tubular structure for anchoring to the surface proper, this being the surface which remains cemented, inside which is solidly installed a coupling device for the parasol support device. Said coupling device consists essentially of a crown support with a female thread on which is fixed the parasol support device to be screwed onto the first structure. For this purpose the parasol support device incorporates in its base an anchor with a male thread or a threaded anchor rod calibrated so that it can be adjusted perfectly to said female thread.

According to another characteristic of the invention, an automatic cover device is in turn fitted to the coupling device, specifically in the crown with the female thread, and its upper flat face lies flush with the surface of the ground when the parasol support is removed, whilst it is pushed to a lower position by screwing when the parasol support is coupled.

With the construction described, and once the device for anchoring to the surface above a calibrated drilled hole made in the ground has been cemented, the device will lie flush with the surface of the ground and with the automatic cover pushed to its sealing position, also made flush at the same level.

The present invention will be described below with reference to the attached drawings, in which:

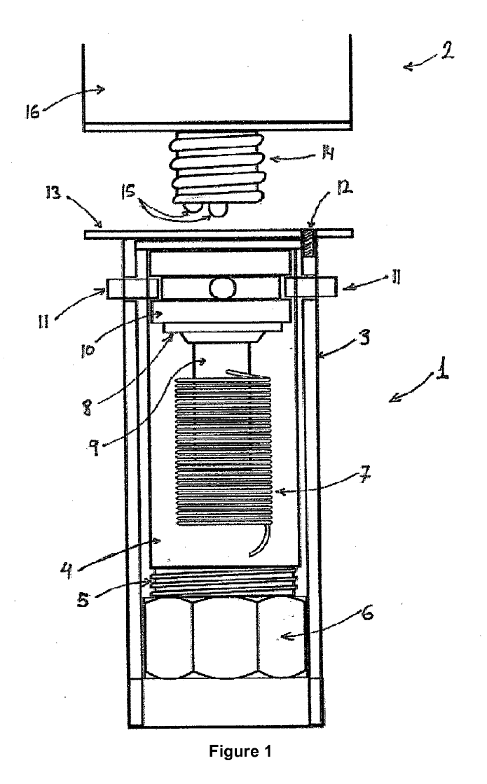

FIG. 1 shows a front view, partially in section, of the surface anchor according to the present invention.

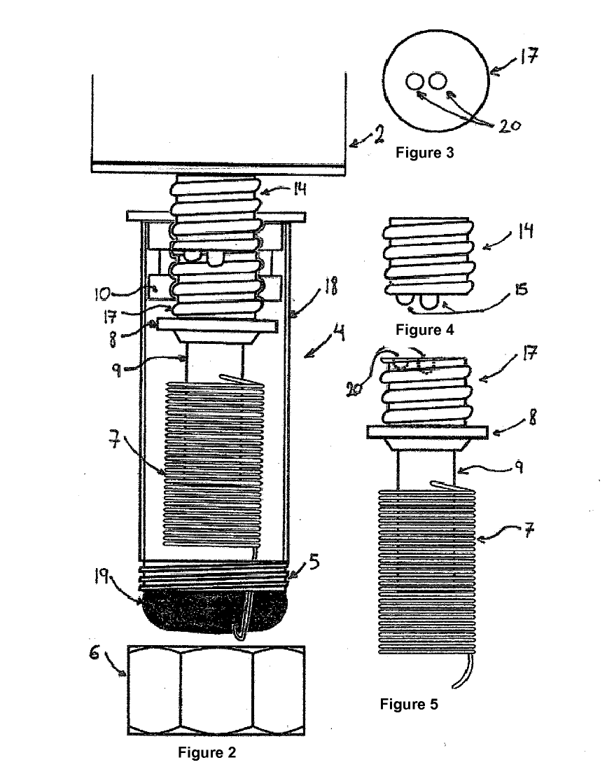

FIG. 2 is a detailed diagram of the invention, where the parasol support is fitted to the coupling device.

FIG. 3 is a detailed diagram, in elevation, of the automatic cover device according to the present invention.

FIG. 4 is a detailed diagram, in a front view, of the threaded rod anchoring the parasol support.

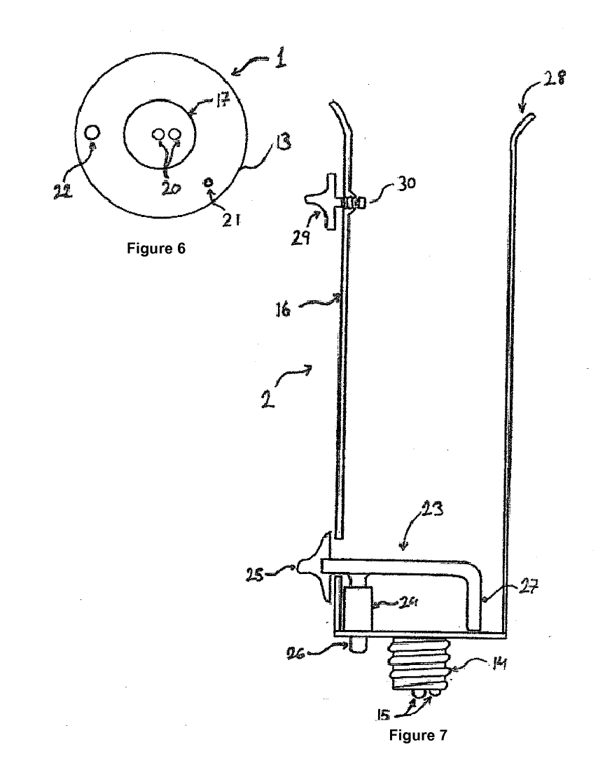

FIG. 5 shows a front view of the automatic cover device. FIG. 6 shows an elevation of the device for anchoring to the surface.

FIG. 7 shows a side view, partially in section, of the parasol support device according to the present invention.

FIG. 1 shows the device for anchoring to the surface -1-, as well as part of a parasol support device -2-. In the anchoring device -1- we observe the tubular anchoring structure -3-, with the coupling device -4- of the support device -2-, which is fitted to the tubular anchoring structure -3- in such a manner that it can be uncoupled, thanks to an anchor -6- constructed by means of a lower anchor with a female thread and a closed base, said base not being shown, which in turn acts as a lower cover for the surface anchoring device, arranged at its lower end in the embodiment shown, and integral with the tubular structure -3- by means of welding in this case. However, it will be understood that both devices may be fixed by other methods, such as mechanical retention, for example. A lower male thread -5- of the coupling device -4- is coupled to said anchor with a female thread -6-, the coupling device being fixed in its position of maximum insertion relative to the tubular structure -3- by means of a locking mechanism, this locking being preferably achieved by at least one upper locking bolt -12- which prevents the relative rotation of both structures.

The coupling device -4- comprises a second tubular structure -18- terminating at its upper end with a surface cover plate -13- which is drilled a hole -21- for the locking bolt -12-.

A female anchor crown -10- has such an outside diameter that it is adjusted within the tubular structure -18-, in its uppermost section, rendering it integral with same by means of captive bolts -11-. Alternatively it may be fixed by welding or by another method which guarantees a solid union without the rotation of both parts. The female anchor crown -10- has on its inner face a female thread that is essentially open at both ends, not shown in this figure, which acts as a device for anchoring the threaded anchoring rod -14- of the parasol support device -2- as well as for guiding the cover device -31-.

According to another development of the invention, as shown in FIG. 2, a lower sealing cover -19-, preferably manufactured of plastic material, is mounted in the lower aperture of the tubular structure -18-.

According to another characteristic of the invention, the cover device -31- has an upper threaded cover -17- with a flat upper face, and screw threading shaped so that it can be coupled to the female thread of the anchor crown -10- under conditions of close adjustment with a sliding capacity, which in its position of rest is pushed by the action of a spring mechanism -7- of the coil type, to an upper position by its guided screwing onto the anchor crown -1-, as shown in FIG. 1. Said threaded cover -17- is integral with an intermediate locking washer -8- at its base, and a lower rod -9-, also integral with same, around which said spring -7- is mounted and anchored to it at one of its ends, the opposite end of the spring being preferably anchored to a hole drilled in the sealing cover -19-, as shown in FIG. 2.

With the structure described, and with the threaded cover -17- in its uppermost position, as shown in FIG. 1, its thread being locked when the locking washer -8- comes into contact with the base of the anchor crown -1-, and its flat end lying flush with the cover plate -13-. With the threaded cover -17- in its lowest position relative to the female anchor crown -1-, its lower rotation will in turn be locked by means of locking devices, such as said return spring -7-, which in its most compressed position acts to lock the cover device -31-, which will prevent complete uncoupling of the cover device -31- relative to the anchor crown -10. This situation is not shown in any figure.

According to another characteristic of the invention, the coupling device -4- is filled with a lubricant with a sealing action, such as a high density mineral-based grease, contained in the tubular structure -18- of same, which facilitates the slip between the threaded cover -17- and the female anchor crown -10-, whilst at the same time preventing the ingress of external bodies between the two elements.

With the structure described for FIGS. 1 and 2, and during the process of assembling the elements of the device for anchoring to the surface -1-, according to the embodiment shown, the lower anchor with a female thread -6- will first be inserted in the tubular anchor structure -3- and coupled by welding.

The components of the coupling device -4- are fitted on the other side. For this purpose the cover plate -13- is welded to the anchor crown -1-, and this is in turn inserted in the upper mouth of the tubular structure -18- and coupled by welding or, as in the example shown, by means of captive bolts -11-.

Similarly, the spring -7- is inserted on the rod -9- of the cover device -31- and anchored at its upper end to same in a hole drilled in the rod -9-. The cover device -31- is then inserted in the tube -18- of the coupling device -4- through the lower aperture of same, and screwed to the anchor crown -10-, after which the plastic cover -19- is mounted in the lower mouth of said tube -18-. Said cover -19- has a guide hole through which the lower end -32- of the spring -7- is inserted when said cover -19- is fitted. Provision will be made for the lower end of the spring -32- to project slightly from the cover -19-, with the latter fitted, so that it can be pulled off from same and folded to prevent it from subsequently slipping through the cover. Moreover, as shown in FIG. 2, said end may be anchored to the cover by nailing it to same once folded. The coupling device -4- may then be filled with the lubricant by injection through the plastic cover -19-.

With the elements of the coupling device -4- already fitted, the latter is then inserted through the upper aperture of the tubular structure for anchoring to the surface -3-, and screwed through its lower end -5- onto the female lower anchor -6- as far as its maximum insertion position. In this position provision will be made for the fixing orifice -21- of the cover plate -13- to coincide with a slot -33- made in the upper edge of the tubular anchor structure -3-, thereby enabling the fixing bolt -12-, which will act as a lock to prevent the free rotation and consequent loosening of one structure relative to the other, to be inserted. Provision will be made, in turn, for said slot -33- to have such a depth that if it is desired to uncouple the coupling device -4- relative to the tubular anchor structure -3-, captive bolt -12- can be pushed downwards until it projects from the orifice -21- of the plate -13- when a fine instrument is applied. The coupling device -4- may therefore be unscrewed if necessary.

With the construction process described, the surface anchor will be ready for use for its subsequent installation in the ground.

According to another characteristic of the invention the parasol support device -2- comprises a threaded anchor rod -14- for fixing to the device for anchoring to the surface -1- and, integral with it, a parasol support structure -16-, as a functional surface device. The threaded anchor rod -14- is designed to be coupled by screwing to an exact position, under locking conditions, to the female thread of the anchor crown (10) through the upper aperture of same, being designed for close adjustment with sliding capacity relative to it. This characteristic can be seen more clearly in FIG. 2, which shows the threaded rod -14- screwed onto the anchor crown -10- of the coupling device -4-.

According to the invention said rod -14- has on its inner face devices for its vertical coupling to the threaded cover -17- in an exact axial direction, specifically a central nipple -15- and a second lateralised nipple -15-, preferably shorter than the first, as shown in FIG. 4, which are coupled to their corresponding negatives -20- formed on the upper face of the threaded cover -17-, as shown in FIGS. 3 and 5. Alternatively the rod could, for example, have a single central nipple with an asymmetrical shape, which would be coupled to its corresponding negative. This is not shown in any figure.

With the structure described and with the threaded anchor rod -14- coupled to the threaded cover -17- of the coupling device -4-, the thread of one being a continuation of the thread of the second, acting integrally as a single threaded rod, as shown in FIG. 2.

As shown in FIG. 7, and according to an optional and preferential embodiment of the support device -2-, the latter constitutes a support device for retaining a parasol or similar, not shown, with a parasol support tube -16- proper, with an upper outlet -28-, preferably diverging, a mechanism for fixing the parasol pole by means of a clip-on bracket -29-, -30, and a locking mechanism -33- mounted on the base of the tube -16-. With the parasol support device -2- mounted on the device for anchoring to the surface -1-, under maximum fixing conditions, said locking mechanism prevents the relative rotation between the two by means of a practical captive bolt -26- fitted on the inside of the support tube -16- and capable of being coupled, under locking conditions, to a hole -22- drilled in the cover plate -13-, and shown in FIG. 6.

According to the optional embodiment shown in FIG. 7, the locking bolt -26- is arranged vertically and is mounted on a guide tube -24-, integral with the base of the support tube. Said bolt -26- is integral at its upper end with a horizontal actuating rod -23-, with an end terminating in an external handle -25- and an angled top arm -27- at the opposite end, the end of which is in contact with the base of the parasol support tube -16-, with the locking mechanism in the locking position, as shown in FIG. 7.

With the structure described, and for mounting the parasol support device -2- on the structure for anchoring to the surface -1-, the male rod -14- of the parasol support -2- is first coupled to the cover -17-, allowing the nipples -15- of the former to coincide with the female orifices -20- of the latter. The parasol support -2- is then rotated in the direction of screwing to the anchor device -1-, which causes the threaded cover -17- to move downwards, whilst at the same time the anchor rod -14- is inserted as far as its position of maximum insertion in which the maximum fixing of the parasol support -2- is obtained. In this position the locking rod -26- of the parasol support -2- will coincide with the locking orifice -22 provided on the cover plate, both locking devices being designed for adjustment of the first on the second under locking conditions. For this purpose the self-weight of the parasol will push said locking mechanism -33- to its locking position due to the thrust exerted by the lower end of the parasol pole on the horizontal rod -23-. On the other hand, for releasing the locking mechanism -33- the parasol will first be removed from the support -2-, and it will subsequently be pulled manually upwards from the handle -25-, which gives rise to uncoupling of the locking rod -26-, thereby allowing the parasol support -2- to rotate in the direction of uncoupling. However, according to an alternative embodiment of the locking mechanism -33-, a spring mechanism may be arranged which, in conditions of rest, and without the parasol installed, it pushes the locking bolt -26- to its release position. This alternative is not shown in any of the figures.

According to an alternative embodiment of the support device, the latter consists of any other functional surface device integral with the threaded anchor rod according to this invention, such as a pivoted access control bar for pedestrians and/or vehicles, or any other urban furniture or hotel furniture device etc.

Although a preferential embodiment of the present invention has been illustrated, it will be understood that various changes and modifications can be made to the structure and arrangement of devices without departing from the scope of the invention, as defined n the attached claims.

1. A surface anchor with an automatic cover, comprising:
A device anchoring to the surface (1) with a tubular surface anchor structure (3), on the Inside of which is fitted integrally a device for coupling a support device (2), with an automatic cover device (31) and a support device that can be coupled, in an exact position under locking conditions, and in a dismountable manner, to the anchor device (1) by screwing of same, characterised in that the tubular surface anchor structure (3) is secured to the surface, preferably by cementing of same, in a hole drilled in the ground.

2. The anchor according to claim 1, wherein, according to a preferred embodiment of the invention, the coupling device (4) of the support device is mounted on the tubular anchor structure (3), in an uncouplable manner, said tubular structure comprising an anchor (6) for said coupling device, preferably arranged at its lower end, and a locking mechanism; characterised in that said anchor is preferably constructed by means of a lower cover integral with the tubular structure by welding or other method suitable for this purpose, being provided with a female thread to which is coupled a male thread (5) of the coupling device, wherein the latter is fixed in its maximum insertion position relative to the tubular structure by means o a locking mechanism, preferably effected by means of at least one upper bolt (12) which prevents the relative rotation of the two structures.

3. The anchor according to claims 1 and 2, wherein the coupling device (4) comprises a second tubular structure (18) terminating at its upper end with a surface cover plate (13) in which a hole (21) can be drilled for the locking bolt (12), a lower sealing cover (19) preferably manufactured from plastic material, said second tubular structure having a male thread (5) for mounting onto the tubular anchor structure (3), and a female anchor crown (10) rendered integral with said tubular structure (18) by means, for example, of at least one bolt (11), or by welding or another method which guarantees the tight connection of both parts; characterised in that, with the tubular structure for anchoring to the surface mounted in the ground, and with the coupling device (4) of the support device (2), mounted on it in the locking position, the cover plate remains level with the surface of the ground.

4. The anchor according to claims 1 and 3, wherein the female anchor crown (10) has on its inner face a female thread proper which acts as an anchor device of the support device, as well as a guide for the cover device (31).

5. The anchor according to claims 1, 3 and 4, wherein the cover device (31) has an upper threaded cover (17) with an upper flat face, and threading designed to be coupled to the female thread of the anchor crown (10), under close adjustment conditions with sliding capacity, which, in its position of rest is pushed by the action of a spring mechanism (7), preferably of the coiled type, to an upper position by guided screwing onto the anchor crown, with an intermediate locking washer (8) and a lower rod (9) around which is mounted said spring, which is anchored to same at at least one of its ends, the opposite end of the spring being preferably anchored to a hole drilled in the sealing cover (19), characterised in that, with the threaded cover in its uppermost position, and its thread being locked when the locking washer comes into contact with the anchor crown, its flat end lies flush with the cover plate (13); and in that, with the threaded cover in its lowest position relative to the female anchor crown, its lower rotation is blocked by means of locking devices, as can said return spring which, in its most compressed position, acts to lock said cover device.

6. The anchor according to claims 3, 4 and 5, characterised in that the coupling device (4) is filled with a lubricant with a sealing action, such as a high density mineral-based grease, contained in the tubular structure (18) of same, which facilitates the slip between the threaded cover (17) and the female anchor crown (10), whilst at the same preventing the ingress of external bodies between the two devices.

7. The anchor according to claims 1, 2, 3, 4 and 5, wherein the support device comprises a threaded anchor rod (14) for its fixing on the device for anchoring to the surface (1), and integral with the latter, a support structure (2) as a functional surface element; the threaded anchor rod is designed to be coupled by screwing, up to an exact position, under locking conditions, to the female thread of the anchor crown (10), through an upper aperture of same, being designed for close adjustment with sliding capacity relative to it, having on its lower face devices (15) for its vertical coupling to the threaded cover (17) in an exact axial direction, such as a central nipple and a second lateralised nipple, preferably shorter than the first, or again, for example, a single central nipple with an asymmetrical shape, which nipples are coupled to their corresponding negatives (20) formed on the upper face of the threaded cover; characterised in that, with the threaded anchor rod coupled to the threaded cover of the anchor device, the thread of the first is a continuation of that of the second, in such a manner that they act integrally as a single threaded rod; and also characterised by the existence of a mechanism for locking the support device which, with the support device mounted on the surface anchor device under maximum fixing conditions, prevents the relative rotation between the two by means of at least one practical bolt (26) mounted in the support device and couplable, under locking conditions, to a hole (22) drilled in the cover plate (13).

8. The anchor according to claim 7, wherein, according to an optional and preferential embodiment of the support device (2), the latter constitutes a support element for retaining a parasol or similar, with a parasol support tube (16) proper, with an upper outlet (28), preferably diverging, a mechanism for fixing the parasol pole by means, for example, of a clip-on bracket (29, 30), and the locking mechanism mounted in the base of the tube, which has the locking bolt (26) in a vertical arrangement, mounted on a tube or guide hole (24) integral with the base of the support tube, characterised in that the bolt is integral at its upper end with a horizontal actuating rod (23) with one end terminating in an external handle (25) and an angled top arm (27< at the opposite end, whose end comes into contact with the base of the parasol support tube with the locking mechanism in the locking position.

9. The anchor according to claim 8, characterised in that, according to an optional embodiment of the locking mechanism (33), the latter has a spring mechanism which, under conditions of rest and without the parasol mounted, pushes the locking bolt (26) to its release position.

10. The anchor according to claim 7, wherein, according to an alternative embodiment of the support device, the latter constitutes any other functional surface element.
